(19) United States
(12) Patent Application Publication
(10) Pub. No.: US 2023/0364626 A1
(43) Pub. Date: Nov. 16, 2023

(54) SHOWERHEAD

(71) Applicant: Kohler Co., Kohler, WI (US)

(72) Inventor: Peter Kajuch, Brookfield, WI (US)

(73) Assignee: Kohler Co, Kohler, WI (US)

(21) Appl. No.: 18/124,353

(22) Filed: Mar. 21, 2023

Related U.S. Application Data
(60) Provisional application No. 63/342,260, filed on May 16, 2022.

(51) Int. Cl. B05B 1/18; B05B 15/654; E03C 1/04

(52) U.S. Cl. CPC B05B 1/185; B05B 15/654; E03C 1/0408

(57) ABSTRACT

A showerhead can include a rear face having an inlet and a front face having a plurality of outlets. The front face can couple to the rear face to define a shell having an internal waterway between the inlet and the plurality of outlets. The showerhead can include a first support disposed within the shell. The showerhead can include a second support disposed within the shell. The front face and the rear face can snap together. The first support and the second support can snap together.

### CROSS-REFERENCE TO RELATED PATENT APPLICATIONS

This application claims priority to U.S. Provisional Patent Application No. 63/342,260, filed May 16, 2022, which is incorporated herein by reference in its entirety.

### BACKGROUND

Showerheads and other spray heads may include various components to facilitate directing a flow of water. In some instances, the positioning of such components may be important to the operation of the showerhead. Accordingly, means for positioning various components of a showerhead relative to one another may be desired.

### SUMMARY

One embodiment of the present disclosure relates to a showerhead. The showerhead can include a rear face having an inlet and a front face having a plurality of outlets. The front face can couple to the rear face to define a shell having an internal waterway between the inlet and the plurality of outlets. The showerhead can include a first support disposed within the shell. The showerhead can include a second support disposed within the shell. The front face and the rear face can snap together. The first support and the second support can snap together.

Another embodiment of the present disclosure relates to a method of manufacturing a showerhead. The method can include placing a protrusion of a first support into an aperture of a second support to couple the first support to the second support. The method can include snapping a front face onto the second support to couple the front face to the second support and the first support. The method can include enclosing the first support and the second support by coupling a rear face to the front face to create an exterior shell.

Another embodiment of the present disclosure relates to a showerhead. The showerhead can include a rear face having an inlet and a front face having a plurality of outlets. The front face can couple to the rear face to define a shell having an internal waterway between the inlet and the plurality of outlets. The showerhead can include a flexible support disposed within the shell. The flexible support can include a plurality of nozzles that each protrude through the plurality of outlets. The showerhead can include a rigid support disposed within the shell. The rigid support can include a plurality of projections to support each of the plurality of nozzles. The front face can removably couple to the rear face. The flexible support can removably couple to the rigid support.

### BRIEF DESCRIPTION OF THE DRAWINGS

FIG. 1 is an exploded perspective view of a showerhead, according to an exemplary embodiment.

FIG. 2 is another exploded perspective view of the showerhead of FIG. 1, according to an exemplary embodiment.

FIG. 3A is a cross-sectional view of the showerhead of FIG. 1, according to an exemplary embodiment.

FIG. 3B is another cross-sectional view of the showerhead of FIG. 1, according to an exemplary embodiment.

FIG. 4 is a rear view of the showerhead of FIG. 1 with a rear face removed from the showerhead, according to an exemplary embodiment.

FIG. 5 is a rear view of a first support of the showerhead of FIG. 1, according to an exemplary embodiment.

FIG. 6 is a front view of a second support of the showerhead of FIG. 1, according to an exemplary embodiment.

FIG. 7 is a perspective cross-sectional view of the second support of FIG. 6, according to an exemplary embodiment.

FIG. 8 is a perspective cross-sectional view of the showerhead of FIG. 1, according to an exemplary embodiment

FIG. 9 is a front perspective view of a portion of the second support of FIG. 6, according to an exemplary embodiment.

FIG. 10 is a cross-sectional view of a portion of a handle of the showerhead of FIG. 2, according to an exemplary embodiment.

FIG. 11 is a perspective view of a portion of a handle of FIG. 10, according to an exemplary embodiment.

FIG. 12 is a rear perspective view of the showerhead of FIG. 1 with a rear face removed from the showerhead, according to an exemplary embodiment.

FIG. 13 is a rear perspective view of a portion of the second support of FIG. 6, according to an exemplary embodiment.

FIGS. 14A-14C are front views of a portion of the handle of FIG. 10 in connection with a portion of the second support of FIG. 6 in various rotational positions, according to an exemplary embodiment.

FIG. 15 is an illustration of steps of a process for manufacturing a showerhead, according to an exemplary embodiment.

### DETAILED DESCRIPTION

Referring generally to the FIGURES, disclosed herein are showerheads having components that snap together without adhesives such that no fasteners are visible on an outer face of the showerhead and the internal components of the showerhead can each be removed from one another. The showerhead generally includes four main components. The first component can be or can include a rear surface that is capable of coupling to a water source. The second component can be or can include a front surface having a plurality of water outlets. The other components can be or can include two enclosed supports within the showerhead (e.g., disposed within an outer surface of the showerhead) that facilitate fastening the rear surface and the front surface or directing water from the water source to the outlets. For example, the rear surface can include at least one inlet capable of receiving water and distributing water to one of the enclosed supports (e.g., a rigid support). The rigid support can facilitate distributing water through various outlets of the second enclosed support (e.g., a flexible support) and through the front surface. The flexible support can include a plurality of attachment points that can snap into pockets on the rigid support. The front surface can include a plurality of attachment clips positioned on the inner surface to clip onto the rigid support, or another component. The rear surface can include a plurality of attachment clips positioned on an inner perimeter of the rear surface that snap into the front surface to define a shell that encloses the rigid and flexible supports. The rigid support can include at least one raised support that is sized and positioned to align with raised alignment keys on the flexible support to facilitate coupling the supports to one another. Additionally or alternatively, the raised supports can be sized and positioned to support the structure of the flexible support and to facilitate routing water to the outlets.

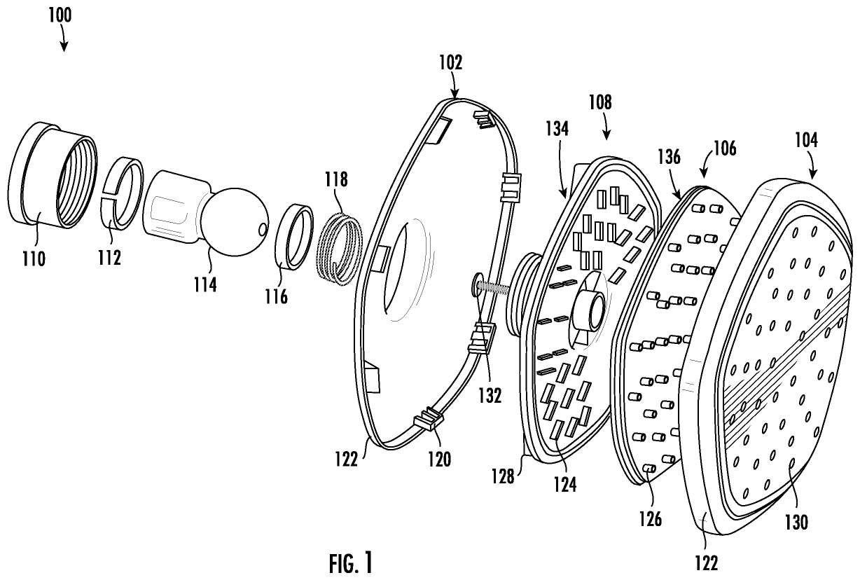

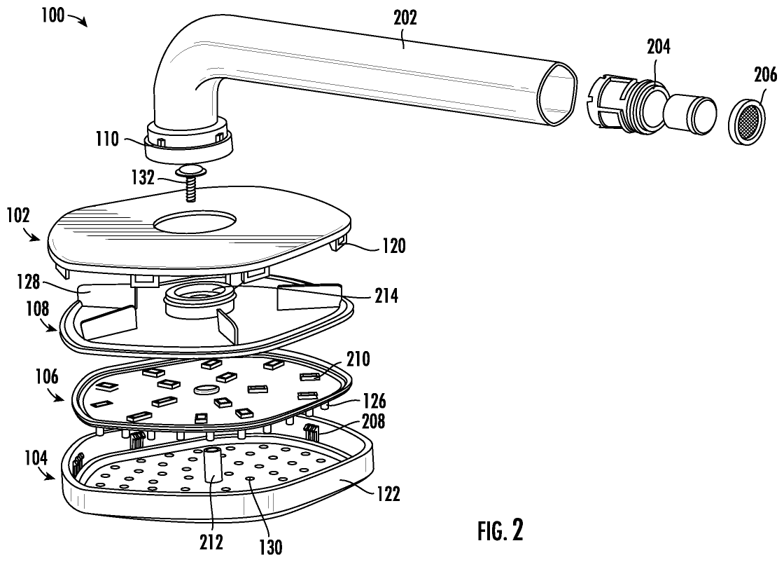

FIG. 1 and FIG. 2 illustrate exploded perspective views of exemplary embodiments of a showerhead 100. The showerhead 100 can include at least one rear face 102, at least one front face 104, a first internal waterway support 106, and a second internal waterway support 108. For example, the rear face 102 and the front face 104 can form a decorative cover of the showerhead 100. The showerhead 100 can be or can include, but is not limited to, a handheld showerhead, a fixed showerhead, a rain showerhead, or a multi-setting showerhead. The showerhead 100 can include one or more components to facilitate coupling the showerhead 100 with a water source (e.g., a municipal water supply). For example, the showerhead 100 can include an inlet 110. The inlet 110 can be or can include a portion of the showerhead 100 that is configured to directly receive water from a water source (e.g., a hole) or a portion that is configured to couple to one or more components (e.g., conduit, pipe, mixer, etc.) that receive water from a water source. The showerhead 100 can include one or more bearings 112, ball joints 114, seals 116, or springs 118 to facilitate coupling to the water source or for allowing movement (e.g., rotation) of the showerhead 100. For example, in some embodiments, the inlet 110 can include or can couple to a ball joint 114 such that the showerhead 100 can rotate at various angles about the ball joint 114. In some embodiments, the inlet 110 is separate from and attached to the rear face 102 such that the inlet 110 and the rear face 102 are separable. In some embodiments, the inlet 110 is integrally formed with the rear face 102 such that the inlet 110 and the rear face 102 are not separable and the rear face 102 does not include any seams between the rear face 102 and the inlet 110.

The showerhead 100 can include additional or alternative components to facilitate coupling the showerhead 100 to a water source. For example, the showerhead 100 can include various handheld rods 202 at various angles. For example, as shown in FIG. 2, the showerhead 100 can include a handle rod 202 having about a 90° angle relative to the front face 104 of the showerhead 100. The showerhead 100 can include various other handle rods 202 including, but not limited to, a straight handle or a handle disposed at another angle.

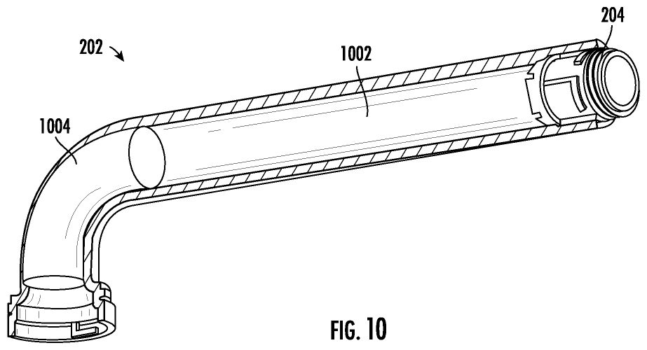

Referring briefly to FIG. 10, the handle rod 202 can include a hollow tube 1002 having an over-molded metallic or non-metallic material. In some embodiments, the hollow tube 1002 can include one or more inserts to facilitate manufacturing the handle rod 202 (e.g., such that the handle rod 202 can be molded over the insert). For example, the handle rod 202 can include a hollow insert 1004 (e.g., a tube within the hollow tube 1002 of the rod) that facilitates transmitting water (e.g., by forming a fluid passage) from the water source to the inlet 110 of the showerhead 100. In some embodiments, the hollow insert 1004 can be made of a metallic material, such as brass (e.g., molded brass). In some embodiments, the hollow insert 1004 can be made of another material, such as plastic (e.g., molded plastic), steel, or other materials. Referring back to FIG. 2, the showerhead 100 can include one or more meshing 206, bushings, adapters 204 (e.g., sonic welded plastic molding adapters), bearings, fasteners, or other components.

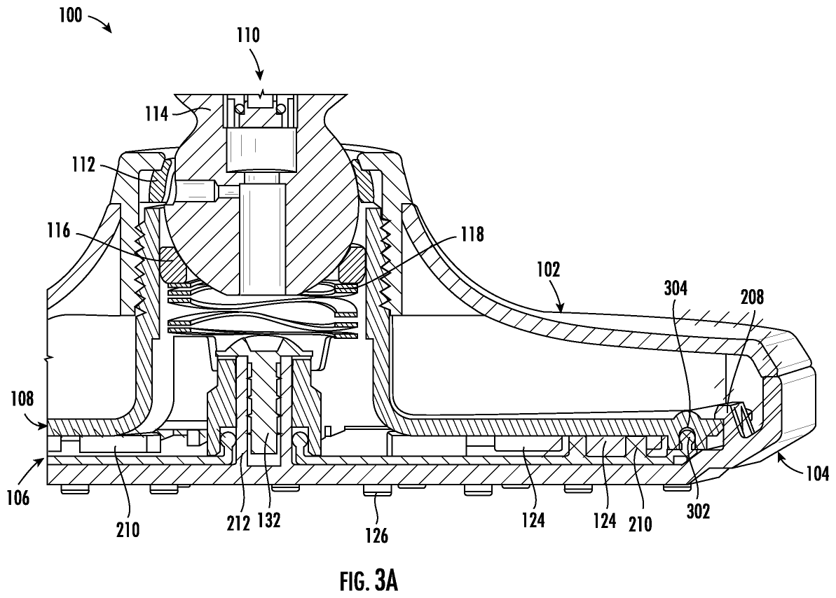

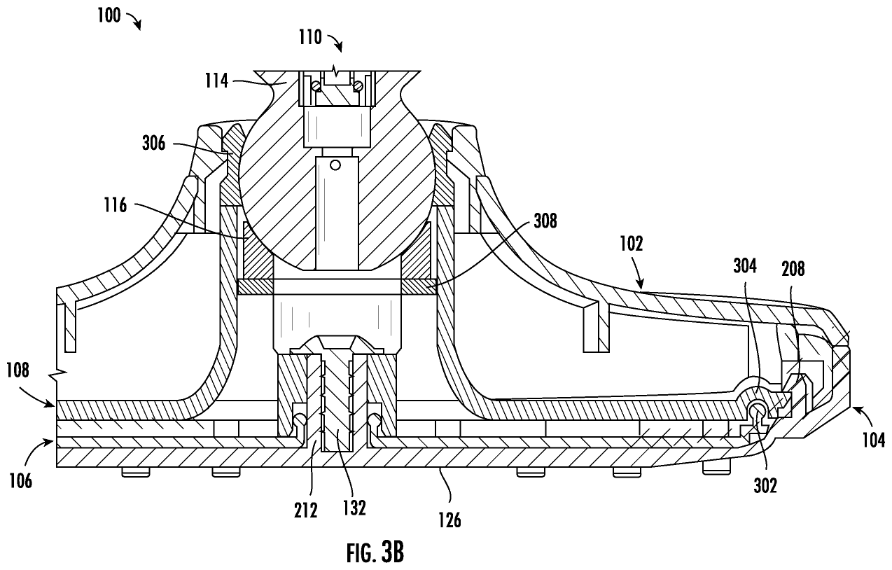

The showerhead 100 can include a plurality of channels, apertures, or other features that are configured to expel water from the inlet 110. For example, the showerhead 100 can include one or more nozzles 126. The nozzles 126 can protrude from one or more portions of the showerhead 100, such as the first support 106, such that the first support 106 can serve as an outlet for the showerhead 100. In some embodiments, the nozzles 126 can protrude through one or more outlets 130 of the showerhead 100. For example, the front face 104 can include a plurality of outlets 130 (e.g., openings) that can receive the nozzles 126 such that at least one nozzle 126 protrudes past the front face 104, as shown in FIGS. 3A and 3B. In some embodiments, the nozzles 126 may not protrude past the front face 104.

The showerhead 100 can include a variety of materials. In some embodiments, the first support 106 is made of a generally flexible material. For example, the first support 106 can include one or more elastomeric materials including, but not limited to, silicone rubber. The first support 106 can include a variety of other materials including, but not limited to, plastic, metal, or a combination thereof. In some embodiments, the second support 108 is made of a generally rigid material. For example, the second support 108 can include one or more polymers including, but not limited to, a glass-filled engineered polymer. The second support 108 can include a variety of other materials including, but not limited to, plastic, metal, or a combination thereof.

In some embodiments, the front face 104 and the rear face 102 are made of one or more plastic materials. For example, the front face 104 or the rear face 102 can be made of acrylonitrile butadiene styrene (“ABS”), or another plastic. The front face 104 or the rear face 102 can include a variety of other materials including, but not limited to, elastomers, metals, or any combination thereof. In some embodiments, the first support 106 and the second support 108 are the only two waterways (e.g., supports, surfaces, strips of materials, fluid flow engines, etc.) disposed between the showerhead shell defined between the front face 104 and the rear face 102.

In some embodiments, the nozzles 126 are shaped, sized, or otherwise formed for easy cleaning. For example, the nozzles 126 can include a rubber material (e.g., silicone rubber) that protrudes from the front face 104 such that the nozzles 126 can be easily accessed without having to take apart the showerhead 100 (e.g., without removing the front face 104). Because the nozzles 126 are formed of silicone rubber, a nonstick surface, dirt, debris, or other particles can be easily removed from the nozzles 126.

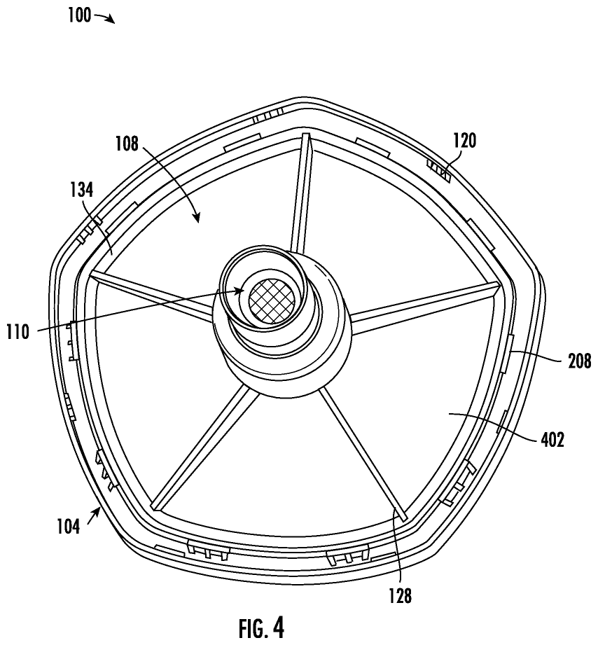

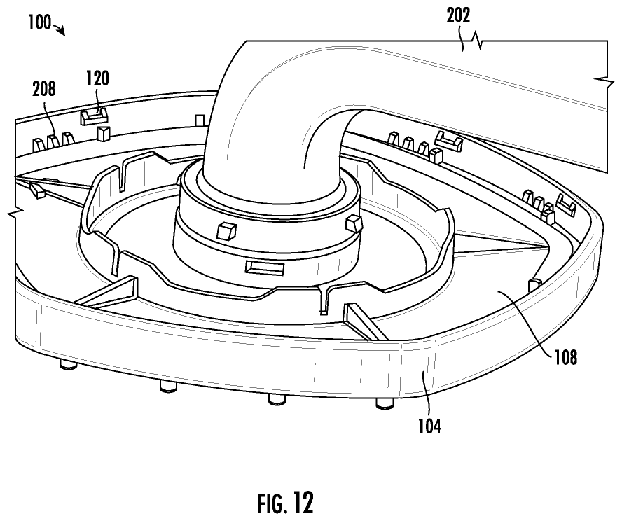

As shown in FIG. 1 and FIG. 2, the rear face 102 or the front face 104 can include at least one tab 120 (e.g., snap, clip, clasp, protrusion, hook) that facilitates coupling the rear face 102 with another component of the showerhead 100, such as the front face 104. The rear face 102 can include a plurality of tabs 120 that connect with a portion of the front face 104 (e.g., with a corresponding plurality of tabs 120 of the front face 104 shown in at least FIG. 4 and FIG. 12). For example, the rear face 102 can include a plurality of tabs 120 disposed along an outer perimeter of the rear face 102 to align with an outer perimeter of the front face 104 and protrude into a portion of the front face 104 such that the rear face 102 and the front face 104 snap together (e.g., formed by pushing the front face 104 and the rear face 102 together).

In some embodiments, the rear face 102 or the front face 104 includes outer walls (e.g., side walls 122) such that the tabs 120 can be positioned along an interior perimeter of the rear face 102 to align with an interior perimeter of the front face 104. In these embodiments, when the front face 104 and the rear face 102 are coupled, the tabs 120 are not visible outside of the showerhead 100 (e.g., outside of the wall 122) as the tabs 120 protrude into the front face 104. In some embodiments, the tabs 120 can be positioned along various other portions of the rear face 102 or the front face 104. For example, at least one tab 120 can be positioned near a center of the rear face 102 (e.g., towards an inlet and away from the side wall 122). At least one tab 120 can be positioned between the center and the side wall 122 of the rear face 102, as another example.

The tabs 120 can facilitate coupling the front face 104 and the rear face 102 such that no adhesives, welded joints, or fasteners are required to couple the front face 104 and the rear face 102. In some embodiments, the tabs 120 can removably couple the front face 104 and the rear face 102 such that the front face 104 can be removed from the rear face 102 by pulling the faces apart from one another (e.g., without breaking any welded joints, adhesive bonds, or other similar components). In some embodiments, the showerhead 100 can include a fixture that couples to the front face 104 or the rear face 102 to form the walls 122 and shield the first support 106 and the second support 108. For example, in some embodiments, the front face 104 or the rear face 102 may not include the walls 122. A separate fixture having the walls 122 (e.g., a hollow tube-like fixture having an outer perimeter that substantially matches the outer perimeter of the front face 104 or rear face 102) can couple to the front face 104 or the rear face 102 to cover the tabs 120 or another internal portion of the showerhead 100.

As shown in FIG. 2, the front face 104 can include at least one clip 208 (e.g., tab, snap, clasp, protrusion, hook) that facilitates coupling the front face 104 with another component of the showerhead 100, such as the second support 108. The front face 104 can include a plurality of clips 208 that connect with a portion of the second support 108. For example, a plurality of clips 208 can be disposed along a perimeter of the front face 104 to clip or snap onto an outer perimeter of the second support 108. In some embodiments, the clips 208 can be positioned along an interior perimeter of the front face 104 (e.g., an inner surface of the sidewall 122). In these embodiments, when the front face 104 and the rear face 102 are coupled, the clips 208 are not visible outside of the showerhead 100 (e.g., outside of the wall 122). In some embodiments, the clips 208 can be positioned along various other portions of the front face 104. For example, at least one clip 208 can be positioned near a center of the front face 104 (e.g., away from the side wall 122). At least one clip 208 can be positioned between a center and the side wall 122 of the front face 104, as another example. At least one clip 208 can be positioned along an outer perimeter of the front face 104, as yet another example.

The clips 208 can facilitate coupling the front face 104 and the second support 108 such that no adhesives or fasteners are required to couple the front face 104 and the second support 108. In some embodiments, the clips 208 can removably couple the front face 104 and the second support 108 such that the front face 104 can be removed from the second support 108 by pulling the front face 104 apart from the second support 108 (e.g., without breaking any welded joints, adhesives, or other similar components). For example, each of the front face 104, the first support 106, the second support 108, and the rear face 102 can removably couple to one another such that the entire showerhead 100 can be taken apart without breaking any welded joints or adhesives.

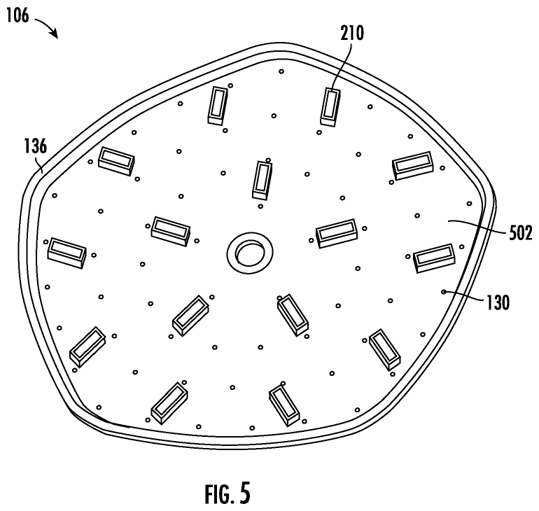

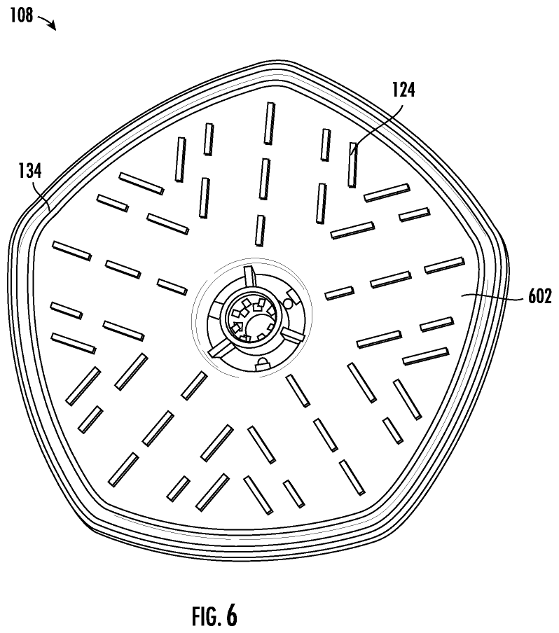

As shown in FIG. 1, the second support 108 can include at least one nozzle support 124 positioned along one or more surfaces of the second support 108. The nozzle supports 124 can be or can include one or more protrusions, apertures, grooves, guides, rods, or other reinforcements that support a portion of the first support 106, or another portion of the showerhead 100. For example, the nozzle supports 124 can include a plurality of protrusions along a front surface 602 (shown in FIG. 6) of the second support 108 that extend towards a rear surface 502 (shown in FIG. 5) of the first support 106 when the second support 108 is coupled to the first support 106.

As shown in FIG. 1, and in greater detail in FIG. 6, the nozzle supports 124 can include a substantially rectangular shape. The nozzle supports 124 can include a variety of other shapes including, but not limited to, circular, oblong, triangular, pentagonal, any combination thereof, or another shape. The nozzle supports 124 can extend in a variety of directions. For example, as shown in FIG. 6, the nozzle supports 124 can extend radially in a variety of directions from a center point of the second support 108. The nozzle support 124 can extend in parallel to one another, perpendicular to one another, or at another angle relative to each other along the front surface 602 of the second support 108, as other examples.

The first support 106 and the second support 108 can include one or more seals (e.g., sealing area 136 of the first support 106 and sealing area 134 of the second support 108) to facilitate sealing at least a portion of the first support 106 with at least portion of the second support 108 such that the water received by the inlet 110 can flow through the opening 214 of the second support 108 and disperse through the nozzles 126 (e.g., and not expel from a side of the first support 106 or the second support 108). For example, the opening 214 can receive water such that water is dispersed radially about the rear surface 502 of the first support 106 and through one or more nozzles 126 protruding from an opposing surface of the first support 106.

In some embodiments, the nozzle supports 124 can each include the same size or shape. In some embodiments, at least two nozzle supports 124 can differ in size or shape. For example, at least one of the nozzle supports 124 can be sized or shaped to couple with one or more alignment keys 210 positioned along a corresponding rear surface 502 of the first support 106. The alignment keys 210 can be or can include one or more protrusions, apertures, grooves, channels, or other features that can receive or otherwise align with a portion of a corresponding nozzle support 124. For example, at least one alignment key 210 can be sized or shaped to receive a portion of a corresponding nozzle support 124 to facilitate aligning the second support 108 relative to the first support 106 when the second support 108 is coupled to the first support 106.

In some embodiments, a subset of the nozzle supports 124 can align with the alignment keys 210 such that at least one nozzle support 124 is positioned at a distance from one or more (e.g., all) of the alignment keys 210 when the second support 108 is coupled to the first support 106. For example, at least one nozzle support 124 can be sized or shaped to abut or contact a portion of the rear surface 502 of the first support 106 positioned between one or more of the nozzles 126 or outlets 130 of the showerhead 100. In other words, when the second support 108 is coupled to the first support 106, a first subset of the nozzle supports 124 align with and contact the corresponding alignment keys 210 and a second subset of the nozzle supports 124 align with and contact a portion of the second support 108.

The showerhead 100 can include a variety of shapes. In some embodiments, the front face 104, the rear face 102, the first support 106, or the second support 108 of the showerhead 100 can include a generally round shape. In some embodiments, the front face 104, the rear face 102, the first support 106, or the second support 108 of the showerhead 100 can include a non-circular (e.g., not round) shape such that the components of the showerhead 100 can be easily aligned during manufacturing. For example, the front face 104, the rear face 102, the first support 106, or the second support 108 can include a general triangular, quadrilateral, pentagonal, hexagonal, heptagonal, or octagonal shape such that the front face 104, the first support 106, the second support 108, or the rear face 102 includes at least two vertices that substantially align with one another, as shown throughout the figures. For example, the pentagonal shape of the showerhead 100 allows the predetermined alignment keys 210 to easily fit with the corresponding nozzle supports 124 as compared to a showerhead 100 having a round shape without any vertices (e.g., points, angles, etc.).

The showerhead 100 can be configured to receive various flow rates. For example, the showerhead 100 can be configured to receive water at an inlet flow rate of up to 2.5 gallons per minute. The showerhead 100 can be configured to receive water at an inlet flow rate of up to 1.8 gallons per minute, as another example. The showerhead 100 can be configured to receive water at an inlet flow rate greater than 2.5 gallons per minute (e.g., up to 8 gallons per minute), as another example.

The showerhead 100 can include a various amount of nozzles 126 or outlets 130. In some embodiments, the showerhead 100 can include 80 nozzles 126. In some embodiments, the showerhead 100 can include more or less nozzles 126. For example, the showerhead 100 can include 45 nozzles 126, 65 nozzles 126, or another amount of nozzles 126. In some embodiments, the nozzles 126 include a diameter in the range of 0.01-1.5 mm (e.g., in the range of 1.0 mm to 1.4 mm). In some embodiments, the nozzles 126 may be smaller or larger. The amount of outlets 130 can be less than, equal to, or greater than the amount of nozzles 126.

In some embodiments, the front face 104 can include at least one guide 212 that receives a portion of a fastener 132 to facilitate coupling the second support 108 to the front face 104, or another portion of the showerhead 100. The guide 212 can be positioned along an interior of the front face 104, as shown in FIG. 2, such that the fastener 132 is not exposed to an exterior of the front face 104 (e.g., the fastener 132 is not visible by a user when the showerhead 100 is coupled or in use). The showerhead 100 can include a fastener-less show face. For example, when the showerhead 100 is manufactured and in use, a user of the showerhead 100 may not see any fasteners positioned along an exterior surface or shell of the showerhead 100 (e.g., an exterior surface of the front face 104 or rear face 102). The guide 212 can include one or more threaded surfaces to threadably couple to the fastener 132.

FIGS. 3A and 3B illustrate cross-sectional views of a portion of the showerhead 100 when the showerhead 100 is coupled. As shown in FIGS. 3A and 3B, the first support 106 lies substantially parallel to, and abuts, in interior surface of the front face 104 such that the nozzles 126 extend through the front face 104 and beyond the front face 104. The first support 106 can include various components to facilitate coupling the first support 106 to the second support 108. For example, the sealing area 136 of the first support 106 can include at least one protrusion 302. In some embodiments, the first support 106 can include a plurality of protrusions 302. The protrusion 302 can be positioned along the rear surface 502 of the first support 106 such that the protrusion 302 at least partially engages (e.g., contact, abut, etc.) a portion of the second support 108. For example, the sealing area 134 of the second support 108 can include at least one aperture 304 (e.g., pocket, groove, hole, channel, etc.) that can receive a portion of the protrusion 302 such that the first support 106 and the second support 108 snap together (e.g., by pushing the first support 106 and the second support 108 together such that the aperture 304 receives the protrusion 302).

The aperture 304 can include at least one portion having a width that is smaller than a corresponding width of the protrusion 302 such that the protrusion 302 engages with and partially deforms within the aperture 304 to couple the protrusion 302 to the aperture 304, as shown in FIGS. 3A and 3B. In some embodiments, the protrusion 302 does not require compression from another portion of the showerhead 100 (e.g., does not require compression from the front face 104) to maintain in position within the aperture 304. The protrusion 302 can be positioned proximate a perimeter of the first support 106 (e.g., as shown by sealing area 136 in FIG. 5). The protrusion 302 can be positioned proximate a center of the first support 106 (e.g., adjacent the guide 212), as another example. The protrusion 302 can be positioned at various other portions of the first support 106 (e.g., between the perimeter and the center), as yet another example.

The protrusions 302 can facilitate coupling the first support 106 and the second support 108 such that no adhesives or fasteners may be required to couple the first support 106 and the second support 108. In some embodiments, the first support 106 and the second support 108 can removably couple to one another such that the first support 106 can be pulled apart from the second support 108 (e.g., without breaking any welded joints or adhesives).

As shown in FIGS. 3A and 3B, the clips 208 can engage with a portion of the second support 108. For example, the clips 208 can snap onto a rear surface 402 (shown in FIG. 4) of the second support 108. In some embodiments, the clips 208 are relatively short in axial length (e.g., the height of the clips 208 extending in a direction that is substantially parallel to the axial direction of the showerhead 100) such that the clips 208 are generally rigid. For example, the axial length of the clips 208 can be in the range of 0.1 to 10 mm. The axial length of the clips 208 can be substantially larger or smaller than 0.1 to 10 mm. In some embodiments, the axial length of the clips 208 can be about 50-90% smaller than a diameter of the front face 104 (e.g., an approximate width of the front face 104 extending in a direction perpendicular to the axial direction of the showerhead 100). For example, the clips 208 can include an axial length that is substantially smaller than a diameter of the front face 104 such that the clips 208 do not significantly bend (e.g., bend more than 15°) when the clips 208 are coupled to the second support 108. In other words, minor deflection of another portion of the showerhead 100, such as the front face 104, allows the clips 208 to snap onto the second support 108. In some embodiments, the diameter of the showerhead 100 is approximately in the range of 90 mm to 150 mm. In some embodiments, the diameter of the showerhead 100 can be significantly larger or smaller. The axial length of the clips 208 can be larger or smaller than 50-90% smaller than a diameter of the front face 104. In some embodiments, each clip 208 of the plurality of clips is the same. In some embodiments, at least one clip 208 differs in size or shape from a second clip 208.

In some embodiments, the showerhead 100 can include one or more structures to facilitate coupling the ball joint 114 with the showerhead 100. For example, as depicted in FIG. 3B, the showerhead 100 can include a connector 306. The connector 306 can extend circumferentially about a portion of the showerhead 100 (e.g., around the ball joint 114). The connector 306 can include one or more protrusions, tabs, clips, or other snapping features that facilitate snapping the ball joint 114 into place within the showerhead 100. For example, the connector 306 can include a plurality of snaps that extend around the ball joint 114. In some embodiments, the connector 306 can receive a portion of the ball joint 114 (e.g., through an orifice in the connector 306) and the showerhead 100 can receive the connector 306 (e.g., via the plurality of snaps at or near the inlet 110) to connect the ball joint 114 with the showerhead 100. In some embodiments, the showerhead 100 can include one or more washers or other bearings 308 to facilitate supporting the ball joint 114 within the showerhead 100.

The second support 108 can include one or more features that facilitate providing strength for the second support 108. For example, the second support 108 can include one or more ribs 128 positioned along the rear surface 402 of the second support 108. The ribs 128 can extend radially from a center of the second support 108 (e.g., near the inlet 110), as shown in FIG. 4. The second support 108 can include any number of ribs 128. For example, the second support 108 can include five ribs 128, as shown in FIG. 4, which depicts the showerhead 100 with the rear face 102 not coupled to the front face 104. The second support 108 can include more or less ribs 128.

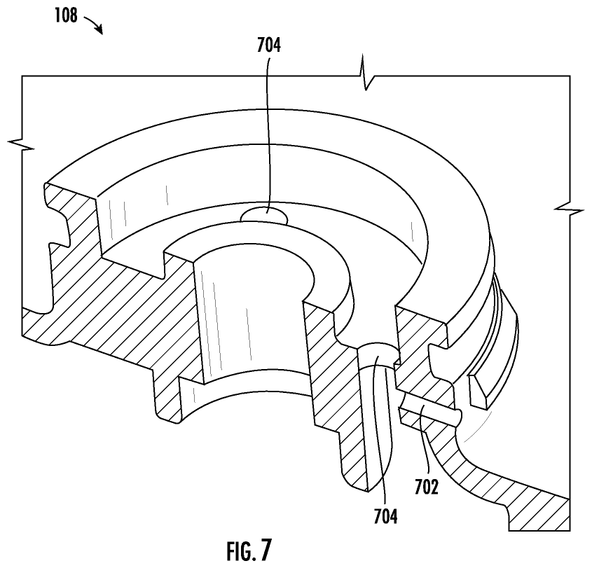

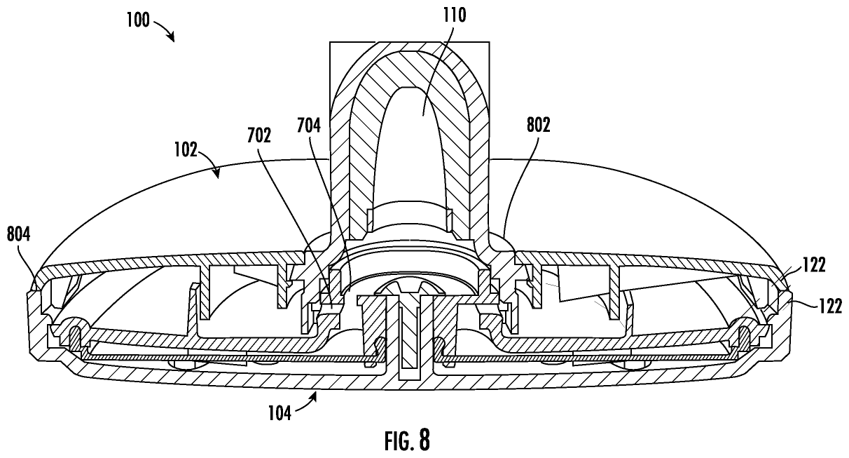

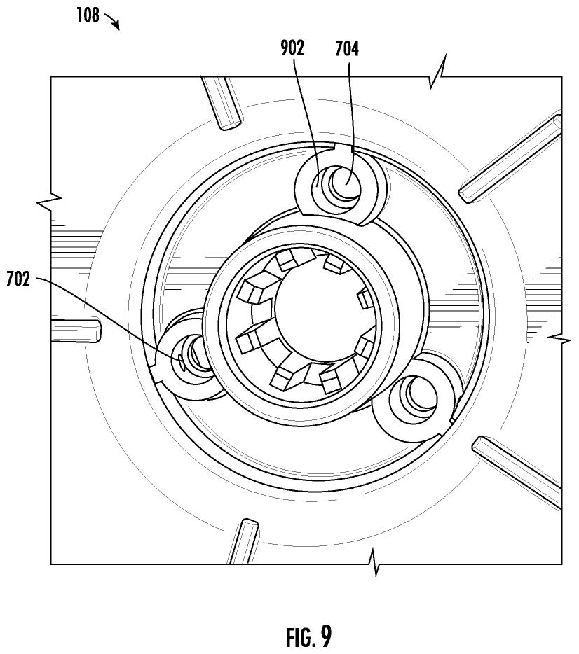

In some embodiments, the showerhead 100 can include one or more components to facilitate creating a Venturi effect within the showerhead 100. For example, as shown in FIGS. 7-9, the second support 108, or another component of the showerhead 100, can include at least one channel 702 that is configured to receive (e.g., intake) air and mix the air with the water from the inlet 110 to integrate air into the water to increase a surface area of the spray of water. The second support 108 can include at least one gap or opening that facilitates pulling air in from an exterior of the showerhead 100 or in which water can drain. For example, a gap can be formed between the front face 104 and the rear face 102 when the front face 104 and the rear face 102 are coupled (e.g., an inner seam line 802 between the rear face 102 and a portion of the inlet 110 and/or an outer seam line 804 between the end of the walls 122 of the front face 104 and a corresponding end of the walls 122 of the rear face 102). This gap can allow for air intake into the showerhead 100 (e.g., into the space between the second support 108 and the rear face 102 when coupled) to mix with the water coming in from the inlet 110. This gap can also allow for water to drain.

As shown in at least FIGS. 7-9, the second support 108 can include one or more holes 704 for water to flow from the inlet 110 and through the second support 108 to disperse water through the first support 106. In some embodiments, the holes 704 are smaller in diameter than the inlet 110.

In some embodiments, at least one of the holes 704 fluidly couples to and/or forms a short pipe 902 (e.g., a channel, pipe, tube, or surrounding area adjacent to the hole 704 in a direction of the flow of water). In some embodiments, a diameter (e.g., an inner diameter) of at least a portion of the short pipe 902 is greater than a diameter of the hole 704 such that a pocket or bubble of air is created within the short pipe 902 where water does not touch (e.g., contact) a side of the short pipe to create a vacuum (e.g., negative pressure) to draw air in.

According to the Venturi effect, a negative pressure chamber is formed at the channel 702 such that air will flow through gaps (e.g., through the inner seam line 802 and/or the outer seam line 804) and through the space between the rear face 102 and the second support 108 to enter the channel 702 to mix with the water. In some embodiments, the channel 702 is positioned on the ball joint 114 such that air mixes with water from the inlet 110 at the ball joint 114.

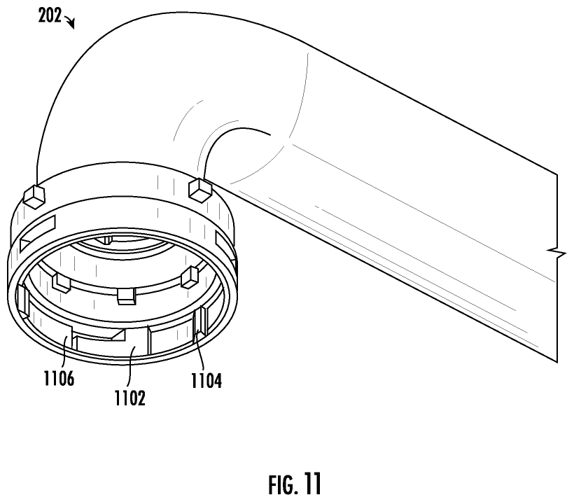

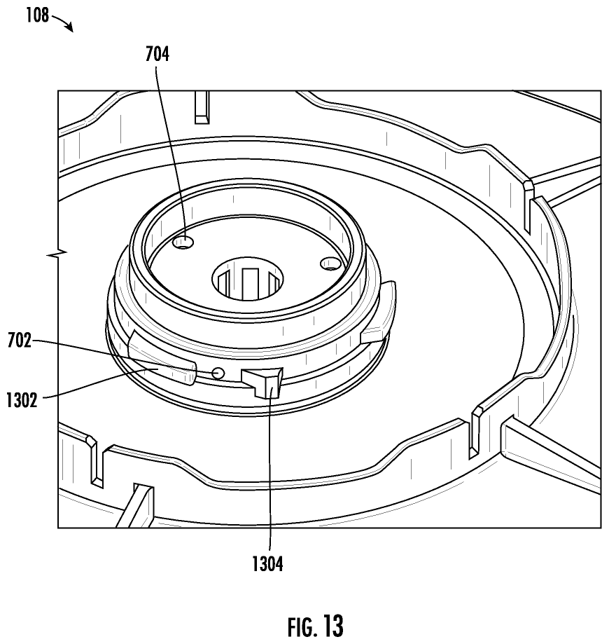

Referring to FIGS. 11-13, the handle rod 202 and/or the second support 108, or another portion of the showerhead 100, can include one or more locking features to facilitate coupling the handle rod 202 to the showerhead 100. For example, the handle rod 202 can include at least one opening 1106, at least one axial locking feature 1102, and/or at least one rotational locking feature 1104. The opening 1106 can include any aperture, hole, slot, or other opening that receives a rotational lock described herein. Each of the axial locking feature 1102 and the rotational locking feature 1104 can be or can include one or more protrusions, extensions, clips, grooves, or other features that facilitate coupling the handle rod 202 to the second support 108 (e.g., as shown in FIG. 12). For example, as shown in at least FIG. 13, the second support 108 can include at least one axial lock 1302 that corresponds to the axial locking feature 1102 of the handle rod 202 and/or at least one rotational lock 1304 that corresponds to the rotational locking feature 1104 of the handle rod 202.

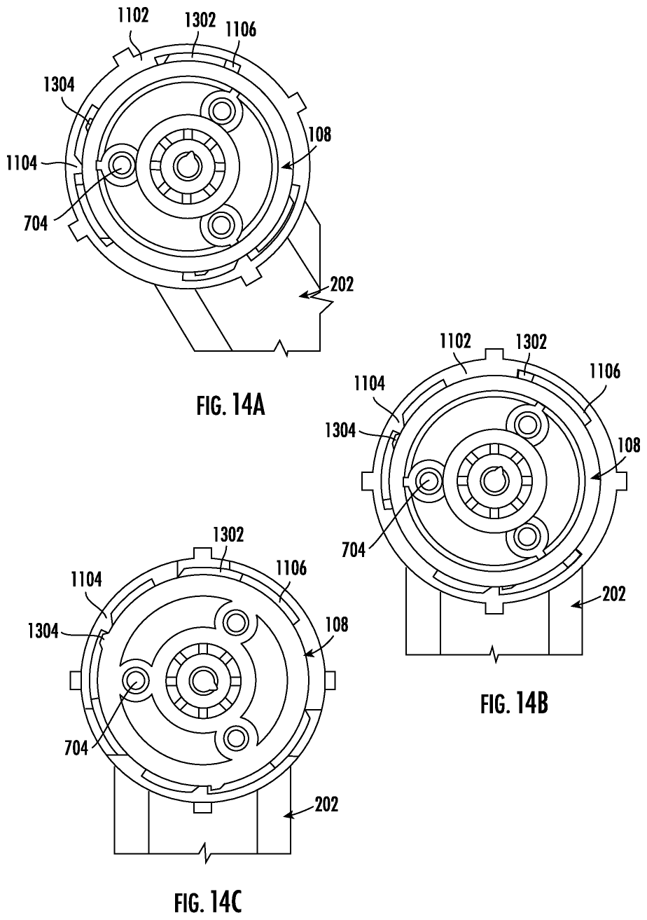

FIGS. 14A-14C depict one example of a connection between the handle rod 202 and a portion of the second support 108 as shown in FIG. 12 (only a portion of the second support is visible for illustrate purposes only). For example, FIG. 14A depicts a first position of the handle rod 202 relative to the second support 108. As shown in FIG. 14A, the opening 1106 of the handle rod 202 can receive the axial lock 1302 of the second support 108 at the first position. At this position, the rotational lock 1304 of the second support 108 can be positioned away from (e.g., not in contact) the rotational locking feature 1104 of the handle rod 202.

FIG. 14B depicts a second position of the handle rod 202 relative to the second support 108 in which the handle rod 202 has been rotated relative to the first position (e.g., rotated between about 10-90 degrees). In the second position, the axial lock 1302 of the second support 108 is rotated such that the axial locking feature 1102 of the handle rod 202 at least partially blocks the axial lock 1302 in an axial direction (e.g., such that the handle rod 202 cannot be separated from the second support 108 in an axial direction). At this position, at least one rotational lock 1304 of the second support 108 engages with (e.g., contacts) a corresponding rotational locking feature 1104 such that the handle rod 202 cannot rotate relative to the second support 108 in at least one rotational direction. FIG. 14C depicts a cross sectional view of the handle rod 202 and the second support 108 in the second position such that the engagement between the rotational lock 1304 and the rotational locking feature 1104 is shown for illustrative purposes. In the second position, the handle rod 202 can lock in place relative to the second support 108 such that the showerhead 100 is coupled to the handle rod 202. In some embodiments, the axial lock 1302 and the rotational lock 1304 can replace and/or be used in combination with threads or fasteners to couple the showerhead 100 and the handle rod 202.

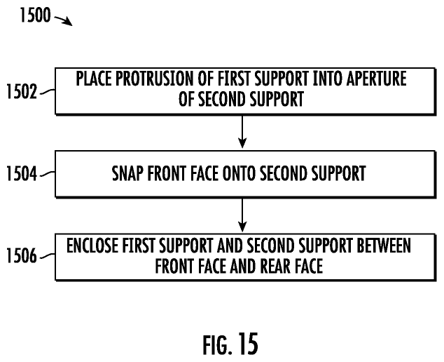

FIG. 15 illustrates a method 1500 of manufacturing the showerhead 100, according to an exemplary embodiment. As a brief overview, the method 1500 includes aligning the components of the showerhead 100 with one another, placing at least one protrusion 302 of the first support 106 into the corresponding aperture 304 of the second support 108, snapping the front face 104 onto the second support 108, and inserting the tabs 120 on the rear face 102 into the front face 104 to enclose the first support 106 and the second support 108.

In greater detail, at step 1502, the components of the showerhead 100 can be aligned. For example, the nozzle supports 124 of the second support 108 can align with the corresponding alignment keys 210 of the first support 106 such that the profile of the first support 106 substantially matches the profile of the second support 108. When properly aligned, the aperture 304 can receive the corresponding protrusion 302 to couple the first support 106 to the second support 108. For example, at least one portion of the first support 106 can abut against the second support 108 such that a surface of the first support 106 contacts a portion of the second support 108 to form a liquid-tight seal at least at one position between the first support 106 and the second support 108.

At step 1504, the front face 104 can snap onto the second support 108 by the clips 208 to couple the front face 104 to the second support 108. The front face 104 can snap onto the second support 108 such that the first support 106 is disposed between the second support 108 and the front face 104, as shown throughout the figures. As described herein, the front face 104 can be sized and shaped such that the front face 104 can slightly bend, deform, or deflect for the clips 208 to position around the second support 108 to snap the second support 108 and the front face 104 together without any need for fasteners or adhesives, such as welding, as shown in FIG. 4. In some embodiments, the front face 104 and the second support 108 can removably couple such that the front face 104 and the second support 108 can be separated without breaking a welded joint or adhesive.

At step 1506, the rear face 102 can snap into or onto the front face 104 by the tabs 120 to couple the front face 104 to the rear face 102. The rear face 102 can snap together with the front face 104 such that the walls 122 of the front face 104 or the rear face 102 cover the first support 106 and the second support 108 such that the supports are enclosed within the front face 104 and the rear face 102 (e.g., the front face 104 and the rear face 102 creates an exterior shell that surrounds the internal waterway supports). In some embodiments, the front face 104 and the rear face 102 can removably couple such that the front face 104 and the rear face 102 can be separated without breaking a welded joint or adhesive. In some embodiments, the showerhead 100 can be coupled such that water is received by the inlet 110, passes through the opening 214 of the second support 108, is dispersed to nozzles 126 of the first support 106, and expels out of the nozzles 126 that protrude through each outlet 130.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the showerheads as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Other substitutions, modifications, changes and omissions may also be made in the design, operating conditions and arrangement of the various exemplary embodiments without departing from the scope of the present invention. For example, any element (e.g., handle rod, ball joint, etc.) disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A showerhead, comprising:
a rear face having an inlet and a front face having a plurality of outlets, the front face configured to couple to the rear face to define a shell having an internal waterway between the inlet and the plurality of outlets;
a first support disposed within the shell; and
a second support disposed within the shell;
wherein the front face and the rear face are configured to snap together; and
wherein the first support and the second support are configured to snap together.

2. The showerhead of claim 1, wherein each of the front face, the rear face, the first support, and the second support are configured to couple to one another without welding or adhesives.

3. The showerhead of claim 1, wherein:
the front face includes a first snap;
the rear face includes a second snap;
wherein the first snap is configured to couple to a portion of the second support; and
wherein the second snap is configured to couple to a portion of the front face.

4. The showerhead of claim 1, wherein:
the first support includes a seal having protrusion; and
the second support includes a seal having an aperture to receive the protrusion to seal the first support with the second support.

5. The showerhead of claim 1, wherein:
an entirety of the first support is disposed within the shell such that the first support is not exposed outside the shell when the front face is coupled to the rear face; and
an entirety of the second support is disposed within the shell such that the second support is not exposed outside the shell when the front face is coupled to the rear face.

6. The showerhead of claim 1, wherein:
the first support is a flexible waterway;
the second support is a rigid waterway; and
the first support and the second support are the only waterways disposed within the shell.

7. The showerhead of claim 1, wherein:
the first support includes at least one alignment key and at least one nozzle that extends through one of the plurality of outlets; and
the second support includes at least one protrusion that engages with the at least one alignment key to support the at least one nozzle.

8. The showerhead of claim 1, wherein the second support includes an axial lock and a rotational lock configured to rotatably engage with a corresponding axial locking feature and rotational locking feature of a handle when the second support is coupled to the handle.

9. The showerhead of claim 1, wherein:
the second support includes a hole having a first inner diameter and configured to receive fluid from the inlet;
a pipe coupled to the hole and having a second inner diameter that is greater than the first inner diameter; and
a fluid channel fluidly coupled to the pipe and configured to intake air into the pipe.

10. A method of manufacturing a showerhead, comprising:
placing a protrusion of a first support into an aperture of a second support to couple the first support to the second support;
snapping a front face onto the second support to couple the front face to the second support and the first support; and
enclosing the first support and the second support by coupling a rear face to the front face to create an exterior shell.

11. The method of claim 10, further comprising aligning the first support with the second support by aligning a nozzle support of the second support with an alignment key of the first support.

12. The method of claim 11, wherein:
the first support includes a non-circular shape; and
the second support includes the non-circular shape such that a profile of the first support matches a profile of the second support.

13. The method of claim 10, wherein each of the front face, the rear face, the first support, and the second support are configured to couple to one another without welding or adhesives.

14. The method of claim 10, wherein:
the front face includes a first snap;
the rear face includes a second snap;
wherein the first snap is configured to couple to a portion of the second support; and
wherein the second snap is configured to couple to a portion of the front face.

15. The method of claim 10, wherein:
an entirety of the first support is enclosed within the exterior shell such that the first support is not exposed outside the exterior shell when the front face is coupled to the rear face; and
an entirety of the second support is enclosed within the exterior shell such that the second support is not exposed outside the exterior shell when the front face is coupled to the rear face.

16. The method of claim 10, wherein:
the first support is a flexible waterway;
the second support is a rigid waterway; and
the first support and the second support are the only waterways enclosed within the exterior shell.

17. The method of claim 10, wherein the first support is disposed between the second support and the front face when the second support is coupled to the front face.

18. A showerhead, comprising:
a rear face having an inlet and a front face having a plurality of outlets, the front face configured to couple to the rear face to define a shell having an internal waterway between the inlet and the plurality of outlets;
a flexible support disposed within the shell, the flexible support having a plurality of nozzles that each protrude through the plurality of outlets; and
a rigid support disposed within the shell, the rigid support having a plurality of projections to support each of the plurality of nozzles;
wherein the front face is configured to removably couple to the rear face; and
wherein the flexible support is configured to removably couple to the rigid support.

19. The showerhead of claim 18, wherein each of the front face, the rear face, the flexible support, and the rigid support are configured to couple to one another without welding or adhesives such that the front face is separable from the rear face.

20. The showerhead of claim 18, wherein each of the front face, the rear face, the flexible support, and the rigid support are configured to removably couple to each other such that the showerhead can be taken apart without breaking a welded joint.
